(19) United States
(12) Patent Application Publication
(10) Pub. No.: US 2010/0006652 A1
(43) Pub. Date: Jan. 14, 2010

(54) Client Welcome Pack

(75) Inventor: Vanessa Louise McDonald, Clovelly (AU)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignee: Boutique Marketing, Clovelly (AU)

(21) Appl. No.: 12/394,036

(22) Filed: Feb. 26, 2009

(30) Foreign Application Priority Data
Jul. 11, 2008 (AU) AU2008203084

(51) Int. Cl. G06Q 30/00; G06Q 90/00; G06K 19/00

(52) U.S. Cl. 235/487; 283/56; 283/117; 705/500; 705/14.3

(57) ABSTRACT

This invention relates to methods and systems for business marketing and client management and in particular to, a client welcome pack which provides a complete customer relationship management/marketing system that is designed to assist a business owner in meeting the basic business objectives that need to be achieved on a daily basis to drive and grow the business.

### BACKGROUND OF THE INVENTION

### Field of Invention

This invention relates to methods and systems for business marketing and client management and, in particular, to a client welcome pack which provides a complete customer relationship management/marketing system that is designed to assist a business owner in meeting the basic business objectives that need to be achieved on a daily basis to drive and grow the business.

Whilst the invention may be applied to any suitable business industry and business entity or corporate structure size, for convenience sake it shall be described herein in terms of a client welcome pack for boutique type businesses in the hair, beauty, day spa, wellness and fitness industries.

Herein, we define ‘clients’ to include an individual or individuals that are acquiring the products or services of a business and includes ‘clients’ as described in one industry such as the beauty industry but also includes other variations to the term ‘client’ used in other industries including ‘members’ such as in the fitness industry.

### OBJECTS AND ADVANTAGES

Marketing and management of client relationships is an essential requirement for any business to maintain and build a client base. Marketing and promotion of the business brings in new clients and good client service leads to client retention and further indirect promotion of the business through word-of-mouth recommendations to friends of the client. However, both of these do require some knowledge and experience and time to be invested, and often get put on the backburner in a busy business.

Current business promotion mechanisms remain inadequate for the following reasons:
Too confusing for staff to implement;
Too hard to track the progress and succession of;
Time consuming to produce in house;
Confusing for the customer; and

Can cost your business expenditure on resources and potential loss of customers if they fail.

Accordingly, it is an object of the present invention to overcome or substantially ameliorate the disadvantages of the prior art by providing a client welcome pack which provides a complete customer relationship management/marketing system that is designed to assist a business owner in meeting the basic business objectives that need to be achieved on a daily basis to drive and grow the business.

### SUMMARY OF THE INVENTION

In accordance with one form of the invention there is provided a client welcome pack including: a packaging; a plurality of components for use in providing marketing and loyalty benefits to an associated business; an application form that is filled out and returned to the associated business to enable registration; with the components each including at least one corporate brand for indicating the associated business and the components each having at least one common client indicator which is exclusive to a single client welcome pack; whereby the client welcome pack provides a predefined complete customer relationship management/marketing system with the plurality of components activated by the completion of the application form and relating the new client with the predefined at least one client indicator so as to assist a business owner in meeting the basic business objectives that need to be achieved on a daily basis to drive and grow the business.

The predefined at least one client indicator relates to a single business to provide an all in one business start up system.

The plurality of components include a predefined at least one client indicator.

A first of the plurality of components is a gift card carries a monetary gift which can preferably be redeemed for any future services and/or products from the company upon the completion and registration of the application form.

The gift card has provided with the predefined at least one client indicator to be entered into a company's system for recalling/recording and updating client and/or gift card information.

The gift card is only activated upon registration.

The plurality of components is a rewards club key tag which is adapted to be kept by the client on a key chain to provide access to loyalty and rewards programmes offered by the company.

The rear side of the rewards club tag is the predefined at least one client indicator to be a barcode which is adapted to store a person's details for the loyalty/rewards program.

The rewards club tag is only activated upon registration.

A third of the plurality of components is secondary tag of a refer-a-friend key tag which is designed to carry a reward for both the new client(s).

The refer-a-friend key tag is provided with the predefined at least one client indicator.

The client transfers possession of the refer-a-friend key tag to a third party who is able to use the key tag to claim its benefits upon which the business owner takes possession of the key tag to be returned back to the original client to further refer other ‘friends’ and the third party is given a client welcome pack for registration.

The refer-a-friend key tag is only activated upon registration.

A client welcome pack wherein the client will receive correspondence from the associated business as well as an incentive or reward.

The client welcome pack further includes marketing items including, but not limited to, a customer survey, procedures guide for customer, business cards, magnets, product samples.

In another form of the invention there is provided a client welcome pack including;

a packaging; an application form with a pre-recorded registration indicia; a plurality of components including: a rewards card with the pre-recorded registration indicia that can be used by a client for redeeming an offer from a specific business; at least one personal key tag with the pre-recorded registration indicia for use by a client in recording data relating to purchases by the client made at the specific business; a plurality of referral key tags with the pre-recorded registration indicia that can be used to refer other parties by the client to the specific business whereby the other parties hand in the referral key tag to redeem a reward from the specific business and the specific business will then return the referral key tag to the client for further referral.

The components each including at least one corporate brand for indicating the associated business and the components each having at least one common client indicator which is exclusive to a single client welcome pack; whereby the client welcome pack provides a predefined complete customer relationship management/marketing system with the plurality of components activated by the completion of the application form and relating the new client with the predefined at least one client indicator so as to assist a business owner in meeting the basic business objectives that need to be achieved on a daily basis to drive and grow the business.

### BRIEF DESCRIPTION OF THE DRAWING FIGURES

The present invention will be more fully understood and appreciated by the following Detailed Description of preferred embodiments of the invention in conjunction with the accompanying drawings, in which:

FIG. 1 shows a perspective view of the client welcome pack according to an embodiment of the invention.

FIG. 2 shows a front and back view of the tags of the client welcome pack according to an embodiment of the invention.

FIG. 3 shows a front and back view of the gift card of the client welcome pack according to an embodiment of the invention.

FIG. 4 shows a front view of the rewards application form of the client welcome pack according to an embodiment of the invention.

FIG. 5 shows a plan view of the envelope of the client welcome pack in an open configuration according to an embodiment of the invention.

FIG. 6 shows an alternative to FIG. 1 whereby the client welcome pack and the plurality of components can be customised for each individual business.

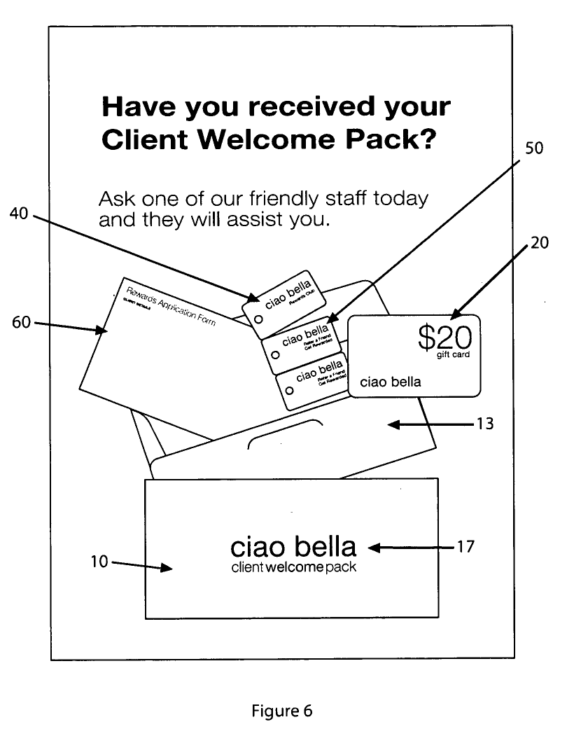

FIG. 7 illustrates as an example the way in which a business can determine the rewards received when using the refer-a-friend gift tag and the associated terms and conditions.

FIG. 8 shows a points redemption menu that will indicate to the clients the point value of each reward.

### DETAILED DESCRIPTION

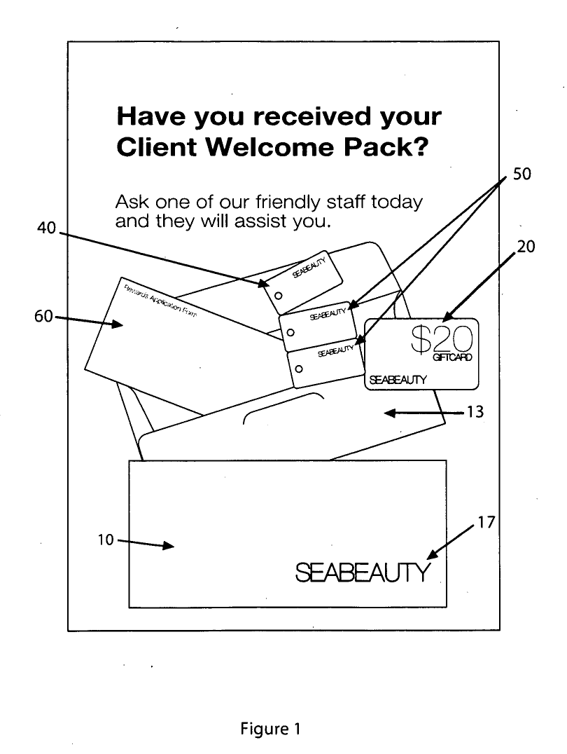

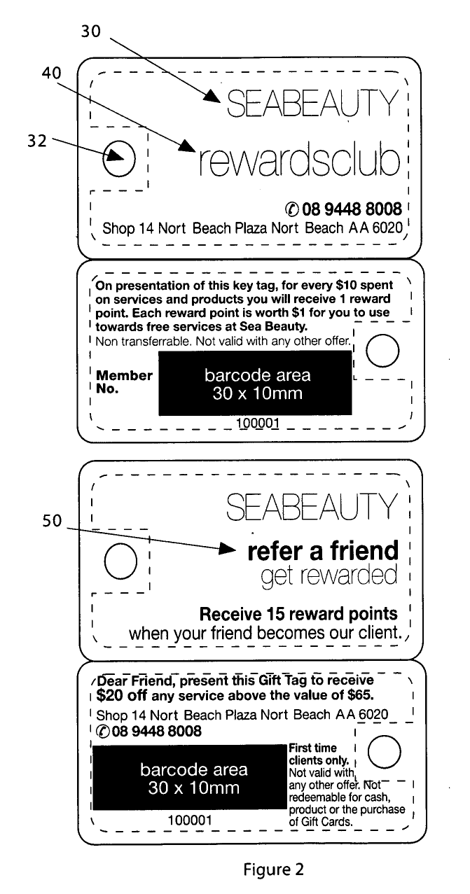

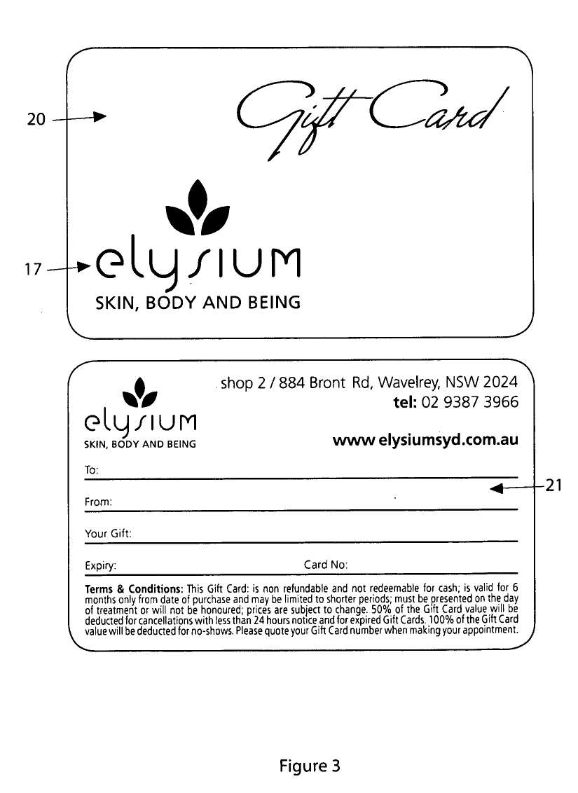

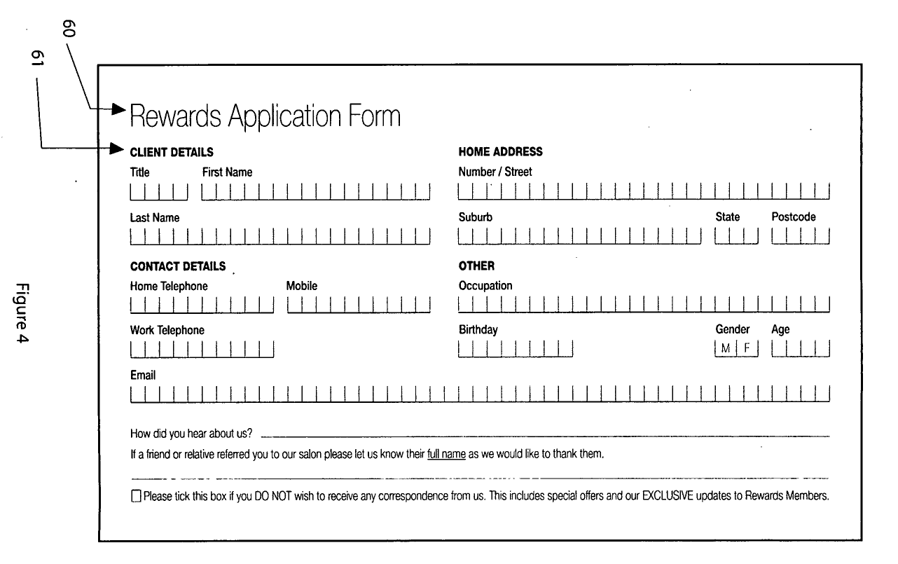

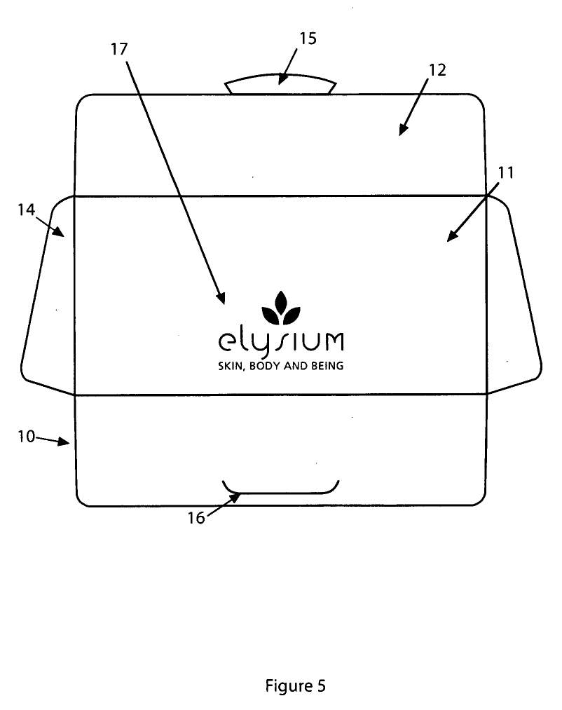

FIGS. 1 to 5 show the client welcome pack and its components according to an embodiment of the invention.

The client welcome pack includes a packaging that is designed to hold a plurality of components making the welcome pack up together. The plurality of components in the packaging are for use in providing marketing and loyalty benefits to an associated business that provides the welcome pack. The first component that is of interest to the client receiving the pack will be an application form 60 that is intended to be filled out and returned to the associated business to enable registration.

Each part of the welcome pack, including the packaging and the plurality of components, will include at least one corporate brand 17. This will indicate the associated business that the pack is originating from. Further, the plurality of components will also each include at least one common client indicator exclusive to a single client welcome pack, in order to act as an identifying mark for each specific pack. A further function of this indicator will be to relate the specific welcome pack to a single business to provide an all in one business start up system.

The client welcome pack provides a predefined complete customer relationship management/marketing system. This is done by the client initially completing the application form 60 and returning it to the associated business for processing and registering. Once registered, the remaining plurality of components will be activated and ready for use by the client. The activated components will be able to be used to provide the associated business in meeting the basic business objectives that need to be achieved on a daily basis to drive and grow the business. Such business objectives can include loyalty programmes and other promotional activities.

The plurality of components includes three different parts. The first of which is a gift card 20 that is used by the client to provide a monetary reward that can be redeemed at the associated business. This card can be redeemed for goods or services that the associated business provides. The associated business can limit which goods or services that are available when the gift card 20 is used. The gift card 20 will only be activated when the client registers their application form 60. The gift card 20 includes the client indicator that is common to the gift pack. The gift card 20 is preferably made of a plastics material but it is envisaged that the gift card 20 can also be made of paper, teslin or PLA Corn. The card can be a set monetary value or it can be set upon registration to a level desired by the client. The gift card 20 is designed to encourage a client to return the associated business to make further purchases or acquire further services therefore, it is envisaged, that the gift card 20 be utilised for other purposes beneficial to the client, such as an appointment card.

The gift card 20 has provided a client data panel 21. The client data panel 21 is a section located on the back of the gift card 20 which is adapted to contain details for the card including, but not limited to, issuer, service, expiration conditions and date, monetary value, applicable redemption or the like.

The plurality of components comprises of key tags 30. The key tags are smaller than the gift card 20 and adapted to incorporate features, such as an aperture 32, to be effectively held on a clients key chain or similar and also include the client indicator. Similarly to the gift card 20, the key tags are preferably made of plastic. It is envisaged that the key tags 30 can also be made of paper, teslin or PLA Corn. The key tags 30 provided comprise of a rewards key tag 40 and a refer-a-friend ‘gift’ key tag 50. Upon receipt of the welcome pack, the club key tags 30 are irremovably attached to the gift card 20

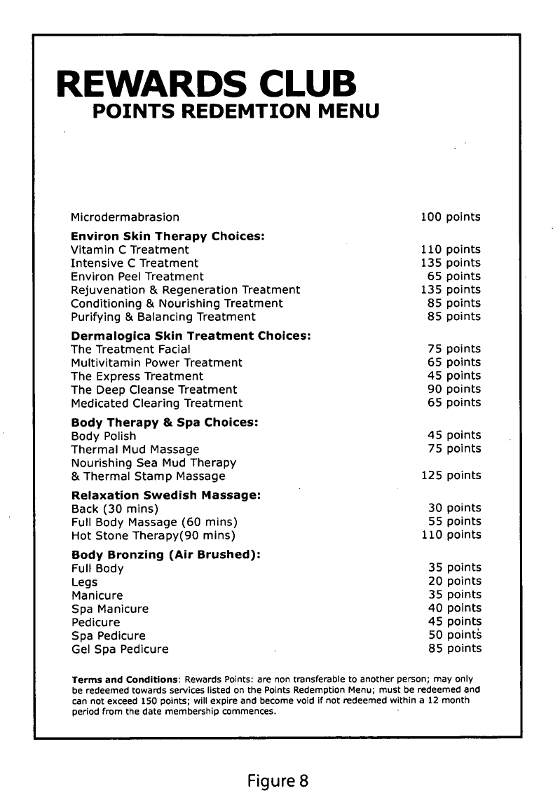

The rewards club key tag 40, the second part to the plurality of components, can be used with ongoing promotions within the associated business. Such ongoing promotions can be rewards or loyalty programmes that reward the client by continued repeat purchases through an accumulation of points that may provide some reward at specific mile stone achievements. As per FIG. 8, the business can determine the number of points required to receive a reward in the form of a product and/or service. When using the rewards key tag 40, it is envisioned that the point of sale will include a display that can indicate how close the client is to a milestone. Much like the gift card 20, this key tag will only be registered and able to be used by the client when their registration has been processed. If desired, the features and functionality of the rewards key tag 40 can be or combined into the gift card such that the gift card has purposes other than holding a monetary value. In addition, FIG. 8 illustrates a point's redemption menu to indicate to the clients the point value according to the services/product offered and further encourages them to continue spending until they accumulate sufficient points to redeem for that service and/or product. This point's redemption menu can be located around the business premise or be included into the client welcome pack as an added feature.

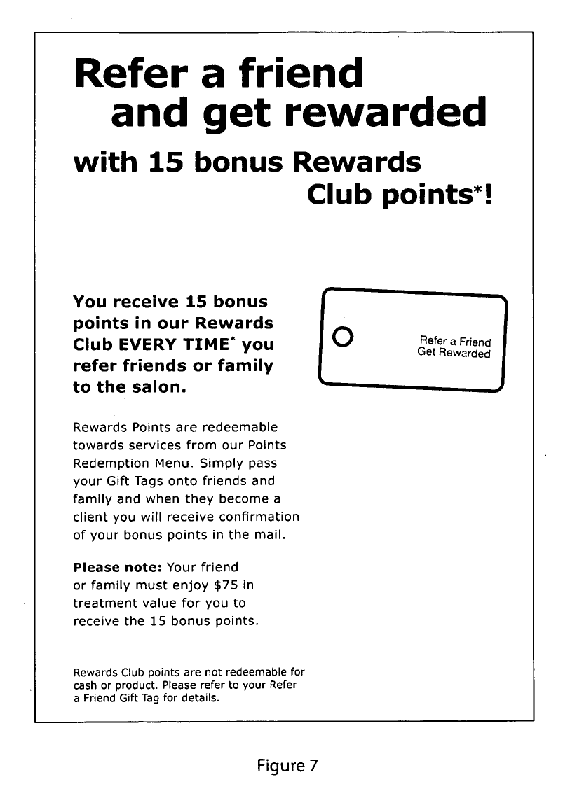

The refer-a-friend ‘gift’ key tag 50, which is the third and final part of the plurality of components, referred herein as refer-a-friend key tag, also includes the client indicator that is unique to the welcome pack and is also attached to the gift card 20 in a similar manner to the rewards key card 40. The refer-a-friend key tags 50 are preferably adapted to promote network marketing through a client referral program which is designed to reward both the new clients and the friend that referred them and, in doing so, the key tags are passed from existing clients of the business to interested friends and family. Details of the reward/gift and its redemption are preferably provided on the back of the tags 50. The refer-a-friend tags 50 are adapted to be branded with the company's logo 17 and corporate identity. The refer-a-friend tags 50 can include a magnetic strip or thermally printed barcode with a unique and identifiable membership number to identify the referring client and award them with, for example, 15 reward points upon use of the key tag by the third party. The refer-a-friend 50 key tag provides for further benefits to the third party, such as a discount upon sale items. Businesses, for example as shown in FIG. 7, can determine the rewards received and the terms and condition as to how much must be spent by the third party before the initial client is rewarded.

Upon the third party claiming the benefits, for example by purchasing a good or service to the required amount, the refer-a-friend key tag 50 is scanned or entered and the third party receives the benefits after which the business owner is then able to reclaim the key tag after use by the third party. The new client, upon turning in the key tag to the business will receive their own Client Welcome Pack in which, as described above, a refer-a-friend key tag 50 is issued upon registration to continue the ‘referring cycle’. In addition, as the registration form, which must be submitted for activation of the refer-a-friend key tag 50, will include the clients name and address, amongst other details, the business is able to send the key tag back to the original client to continue referring other parties together with a customised thank you card or letter with a gift or reward from the business in appreciation of the referral.

The client indicator that is present on all parts of the plurality of components described above can be in the form of a thermally printed bar code, magnetic strip or other scannable marking. This will allow electronic recording and tracking of the use of each of the components linked to a specific client indicator. The scanned or entered data collected by the company is collected and stored on a system or software for recalling, recording and updating client and/or gift card information upon use of one of the plurality of components or internal auditing. Other indicia may be included on all of the plurality of components, such as client or membership numbers, but need not be scannable.

The identifiable barcode, magnetic strip or number will differ amongst the Client Welcome Packs however, the one Client Welcome Pack will incorporate the same identifiable feature, for example the same number or code, to ensure that the client is able to be identified and able to be awarded for use of the components in the Client Welcome Pack.

The client packaging, 10, which is adapted to hold the contents of the pack is in the form of an envelope 10. The envelope is rectangular in shape. However, it is envisaged that any other suitable shape may also be adopted. It is further envisaged that the style and dimensions may be varied to suit user requirements and/or better fit the contents of the welcome pack. The envelope 10 will be branded with a company's logo 17 and corporate colours and identity. The envelope 10 can preferably be folded out into a flat configuration to include a middle portion 11, a top portion 12, a bottom portion 13 and two side flap portions 14. The envelope can be formed by folding the side flap portions 14 and then the bottom portion 13 followed by the top portion 12. It is envisaged that the bottom portion 13 and side flap portions 14 may be permanently secured in place, using a suitable adhesive or the like, or remain unsecured and require folding for use. When in a folded configuration, the middle portion 11 will form the front of the envelope and the top, bottom and side portions 12, 13, 14 will come together to form the back of the envelope. Provided on the edge of the top portion 12 is preferably a securing means 15 for sealing the envelope closed. In the preferred embodiment, the securing means is in the form of a tab member 15 which is integrally formed with and extends outwardly from the edge of the top portion 12. The side edges of the tab member 15 are preferably shaped such that once the tab 15 is inserted into a receiving means 16, the side edges will extend beyond the end of the receiving means 16 to prevent the tab from coming back out without requiring an additional force to release the temporary lock. In an alternate embodiment, it is envisaged that the securing means may be an adhesive or other suitable securing means. Provided on the bottom portion 13 is a slot 16. The slot 16 is aligned horizontally with the envelope 10 and is adapted to receive the tab member 15 therein in order to provide a closure for the envelope 10 and seal the contents therein.

In addition, the business owner is able to contact clients for reasons such as issuing catalogues, brochures, advertisements of sales etc given that details of clients will be recorded in their system when registering the initial application form. In addition, courtesy calls can be made by the business to ensure the client is able to take full advantage of their rewards before the expiry date. Further, the software/system utilised by the business owner can display useful information to the business owner in regards to clients preferences towards certain products/services, and frequency of their visit/purchase.

The client welcome pack preferably includes at least one marketing item which is adapted to assist the company in using the client welcome pack to its full potential to promote sustained business and growth. The marketing item(s) may preferably include, but not be limited to, the following:

Customer survey—gains feedback from the client regarding the quality of the service they are receiving to improve business processes and standards

Business cards—to provide to existing and a third party to promote the business and its services.

Procedures guide—provides instructions and guidance to the customer on how to use the client welcome pack and its components.

Product samples—to provide the client with an indication as to the type and quality of products sold or used.

In further embodiments of the invention, it is envisaged that the additional items for promoting the business and carrying the business' corporate identity may also be utilised such as corporate branded magnets or nail files or the like.

Provided with the client welcome pack is preferably at least one instructional tool which can be provided to the business to teach new and existing clientele how to use the client welcome pack. The instructional tools may preferably include, but not be limited to, the following:

Procedures guide—which can be in the form of an introductory letter, to welcome the client and provides instructions and guidance on how to use the client welcome pack and its components

Script—provides an example of delivery of the client welcome pack to new and potential clients.

The client welcome pack provides a complete customer relationship marketing/management system which is designed to assist a boutique style business/company to meet the basic business objectives that need to be achieved everyday to drive and grow the business. The client welcome pack can be used in organisations with automated or manual processing systems. The client welcome pack provides the following benefits for the business:

Gain new clients: implement a client referral programme (through the Refer-a-Friend Key Tag)

Retain current clients (through the Rewards Club Key Tag)

Re-book clients (through the $20 Gift Card)

Cross sell and increase services/retail products (through the monetary Gift Card)

Recognition and reward clientele (through the 2 Refer-a-Friend Key Tags 50)

Increase business on slow trading days (through the Rewards Club Key Tag 40)

Guarantees accurate collection of client data (through the Rewards Club Application DL insert).

In further embodiments of the invention, it is envisaged that the components may be modified or customised to suit the preferences of the business. In one example the key card can be shaped in similar size and proportions as a credit card. This may be particularly useful where the client or client base for a particularly business would be reluctant to carry a key tag. In another example, the gift card may be provided in a key tag format or one or more of the cards/tags may be omitted and/or replaced with different cards/tags to better suit the needs of a particular business. In addition, the plurality of components can be used by the business for multiple purposes so that, for example, the rewards club key tag can also serve as an appointment card for the client. Another variation can allow for the introduction of a small ‘set-up’ charge for membership so that the client is required to invest in the client welcome pack before being issued with such.

To ensure the correct implementation of the client welcome pack the business will receive an implementation guide along with the opportunity to attend online training or particular workshops aimed at teaching the staff within the business on how to correctly implement the client welcome pack. Such workshops can provide scripts to ensure that employees adequately explain to the client the procedures involved and the benefits to them. Through the use of the teaching techniques, the business team is able to implement the client welcome pack correctly and further ensures that clients participate in redeeming points and circulating their refer-a-friend gift tags.

While we have described herein a particular embodiment of a client welcome pack, it is further envisaged that other embodiments of the invention could exhibit any number and combination of any one of the features previously described. However, it is to be understood that any variations and modifications can be made without departing from the spirit and scope thereof.

What is claimed is:

1. A client welcome pack including;
a packaging;
a plurality of components for use in providing marketing and loyalty benefits to an associated business;
an application form that is filled out and returned to the associated business to enable registration;
with the components each including at least one corporate brand for indicating the associated business and the components each having at least one common client indicator which is exclusive to a single client welcome pack;
whereby the client welcome pack provides a predefined complete customer relationship management/marketing system with the plurality of components activated by the completion of the application form and relating the new client with the predefined at least one client indicator so as to assist a business owner in meeting the basic business objectives that need to be achieved on a daily basis to drive and grow the business.

2. A client welcome pack according to claim 1 wherein the predefined at least one client indicator relates to a single business to provide an all in one business start up system.

3. A client welcome pack as claimed in claim 1 wherein the plurality of components include predefined at least one client indicator.

4. A client welcome pack as claimed in claim 1 wherein a first of the plurality of components is a gift card carries a monetary gift which can preferably be redeemed for any future services and/or products from the company upon the completion and registration of the application form.

5. A client welcome pack as claimed in claim 4 wherein the gift card has provided with the predefined at least one client indicator to be entered into a company's system for recalling/recording and updating client and/or gift card information.

6. A client welcome pack as claimed in claim 5 wherein the gift card is only activated upon registration.

7. A client welcome pack as claimed in claim 1 wherein a second of the plurality of components is a rewards club key tag which is adapted to be kept by the client on a key chain to provide access to loyalty and rewards programmes offered by the company.

8. A client welcome pack as claimed in claim 7 wherein provided on the rear side of the rewards club tag is the predefined at least one client indicator to be a barcode which is adapted to store a person's details for the loyalty/rewards program.

9. A client welcome pack according to claim 8 wherein the rewards club tag is only activated upon registration.

10. A client welcome pack as claimed in claim 1 wherein a third of the plurality of components is secondary tag of a refer-a-friend key tag which is designed to carry a reward for both the new client(s).

11. A client welcome pack according to claim 10 wherein the refer-a-friend key tag is provided with the predefined at least one client indicator.

12. A client welcome pack as claimed in claim 11 wherein the client transfers possession of the refer-a-friend key tag to a third party who is able to use the key tag to claim its benefits upon which the business owner takes possession of the key tag to be returned back to the original client to further refer other ‘friends’ and the third party is given a client welcome pack for registration.

13. A client welcome pack according to claim 12 wherein the refer-a-friend key tag is only activated upon registration.

14. A client welcome pack as claimed in claim 13 wherein the client will receive correspondence from the associated business as well as an incentive or reward.

15. A client welcome pack as claimed in claim 1 which further includes marketing items including, but not limited to, a customer survey, procedures guide for customer, business cards, magnets, product samples.

16. A client welcome pack including;
a packaging;
an application form with a pre-recorded registration indicia;
A plurality of components including:
a rewards card with the pre-recorded registration indicia that can be used by a client for redeeming an offer from a specific business;
at least one personal key tag with the pre-recorded registration indicia for use by a client in recording data relating to purchases by the client made at the specific business;
a plurality of referral key tags with the pre-recorded registration indicia that can be used to refer other parties by the client to the specific business whereby the other parties hand in the referral key tag to redeem a reward from the specific business and the specific business will then return the referral key tag to the client for further referral.

17. A client welcome pack according to claim 15 wherein the components each including at least one corporate brand for indicating the associated business and the components each having at least one common client indicator which is exclusive to a single client welcome pack;
whereby the client welcome pack provides a predefined complete customer relationship management/marketing system with the plurality of components activated by the completion of the application form and relating the new client with the predefined at least one client indicator so as to assist a business owner in meeting the basic business objectives that need to be achieved on a daily basis to drive and grow the business.
